(19) United States
(12) Patent Application Publication
(10) Pub. No.: US 2025/0230898 A1
(43) Pub. Date: Jul. 17, 2025

(54) AIDC DEVICE CRADLE

(71) Applicant: Charles Cagliostro, Bronxville, NY (US)

(72) Inventor: Charles Cagliostro, Bronxville, NY (US)

(21) Appl. No.: 19/096,402

(22) Filed: Mar. 31, 2025

Related U.S. Application Data
(63) Continuation-in-part of application No. 17/674,115, filed on Feb. 17, 2022, now abandoned.
(60) Provisional application No. 63/220,372, filed on Jul. 9, 2021.

(51) Int. Cl. F16M 13/02; B42D 25/23; B42D 25/305; F16M 11/04; F16M 11/10; G06K 19/00; H02J 7/00

(52) U.S. Cl. CPC F16M 13/022; B42D 25/23; B42D 25/305; F16M 11/041; F16M 11/10; G06K 19/005; H02J 7/0044; H02J 2310/22

(57) ABSTRACT

An AIDC device cradle for a phone-based PDA with a camera and bar code reader includes a receiver to hold the PDA in a defined orientation and a license holder portion that positions a driver's license for imaging or scanning. A mirror redirects the bar code reader's beam to align with the license, and an optional lock aperture permits securing the PDA against removal. The cradle's walls block stray beams, while grooves or slots guide the license and ensure proper lateral placement. Electrical contacts can interface with the PDA or its protective case for charging and data.

### CROSS-REFERENCE TO RELATED APPLICATIONS

The present application is a continuation in part application to U.S. Utility patent application Ser. No. 17/674,115 filed, Feb. 17, 2022 which claims priority to U.S. Provisional Patent Application Ser. No. 63/220,372, filed on Jul. 9, 2021 entitled “AIDC Device Cradle”, the disclosure of which is hereby incorporated in its entirety at least by reference.

### BACKGROUND OF THE INVENTION

### 1. Field of the Invention

The present invention generally relates to AIDC devices, more specifically it relates to a locking adjustable cradle with onboard charger for AIDC devices.

### 2. Description of Related Art

AIDC (Automatic identification and data capture) is a term used to group together several different device technologies that are used to automatically identify items, collect data, and enter this data into computer systems. Most of the data that is captured by such devices is attached to barcodes, RFID-equipped access cards, or Smart Cards which can be enhanced further with the use of Biometric data. There have been advancements in AIDC over the years and it is now possible for users around the world to interact with millions of business processes and systems using AIDC devices. Object tracking using Electronic Article Surveillance (EAS) systems which also uses RFID Tags prevents theft of the items from stores. Locating objects through the use of Real Time Locating Systems (RTLS) to name just a couple of the many opportunities which AIDC based technology has to offer. As such devices began to appear in most retail environments, merchants began looking at ways to make them more stable, secure and more presentable to their operators. Consequently, a solution is needed.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present invention to provide an AIDC cradle that can receive an AIDC device that is configured to adjust the scanner beam from a vertical path to a horizontal path. It is another object of the present invention to provide an AIDC cradle that is configured to securely mount to a flat surface.

In order to do so, an AIDC device cradle is provided, comprising a receiver formed by a plurality of walls, the receiver configured to hold a PDA or AIDC device having at least one camera and at least one bar code reader in a predefined orientation; and, a mirror mounted in the cradle, the mirror being arranged to redirect a scanning beam from the at least one bar code reader from a vertical path to a horizontal path. Existing AIDC cradles fail to redirect scanning beams efficiently, requiring larger footprints or exposing stray laser light, issues addressed by the present invention's mirror and beam-blocking wall.

In one embodiment, a license holder portion is disposed on or within the cradle, the license holder portion adapted to support a driver's license in a field of view of the at least one camera or the at least one bar code reader. In one embodiment, the receiver comprises a front wall cut away to expose a screen of the AIDC/PDA when the AIDC/PDA is placed in the cradle; and a back wall cut away to expose the camera of the AIDC/PDA when the AIDC/PDA is placed in the cradle. In another embodiment, the license holder portion includes at least one wall configured to block a direct path of the scanning beam beyond an outer footprint of the cradle, thereby preventing stray laser light from extending outward. In one embodiment, at least one groove or slot is provided, the groove or slot being dimensioned to hold a second license or identification card in a position suitable for the at least one camera. In one embodiment, a lock aperture is provided and aligned so that, when the AIDC/PDA is placed in the receiver, a security lock can be inserted through the lock aperture and into a corresponding recess of a protective case surrounding the PDA, thereby preventing removal of the AIDC/PDA from the cradle. In yet another embodiment, the mirror is positioned in close proximity to an emission point of the at least one bar code reader so as to minimize the required size of the mirror while maintaining an effective scanning angle. In one embodiment, electrical contacts are arranged to connect with corresponding contacts on the AIDC/PDA or on a case in which the AIDC/PDA is housed, thereby enabling data or power transmission when the AIDC/PDA is positioned in the receiver. In another embodiment, the license holder portion includes opposing lateral features selected from the group consisting of bumps, ribs, and grooves, which establish lateral positioning of the license relative to the bar code reader's optical axis. In one embodiment, walls of the receiver form a tapered opening at an upper portion to guide insertion of the AIDC/PDA into the cradle and help align the PDA with the mirror.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a right exploded perspective view of an AIDC device cradle according to an embodiment of the present invention.

FIG. 2 is a left perspective view of the AIDC device cradle according to an embodiment of the present invention.

FIG. 3 is a top perspective view of the AIDC device cradle with a detailed view showing the charger according to an embodiment of the present invention.

FIG. 4 illustrates various views of an AIDC device cradle presenting as docking station according to an embodiment of the present invention.

FIG. 5 illustrates the docking station with an AIDC device positioned within the dock according to an embodiment of the present invention.

FIG. 6 illustrates the locking feature of the docking station according to an embodiment of the present invention.

FIG. 7A is a top view of the docking station with AIDC device and two drivers licensees positioned in the dock according to an embodiment of the present invention.

FIG. 7B is a sectional view taken along section line B-B of FIG. 7A.

FIG. 7C is a sectional view taken along section line C-C of FIG. 7A.

FIG. 8A is a top view of the docking station with two driver's licenses positioned in the dock according to an embodiment of the present invention.

FIG. 8B is a sectional view taken along section line B-B of FIG. 8A.

FIG. 8C is a sectional view taken along section line C-C of FIG. 8A.

FIG. 9A is a top view of the docking station with an AIDC device and two driver's licenses positioned in the dock according to an embodiment of the present invention.

FIG. 9B is a sectional view taken along section line B-B of FIG. 9A.

FIG. 9C is a sectional view taken along section line C-C of FIG. 9A.

FIGS. 10-11 illustrate various views of the AIDC case according to an embodiment of the present invention.

FIGS. 12-15 illustrate various views of the AIDC case and device according to an embodiment of the present invention.

### DETAILED DESCRIPTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide an AIDC device cradle.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

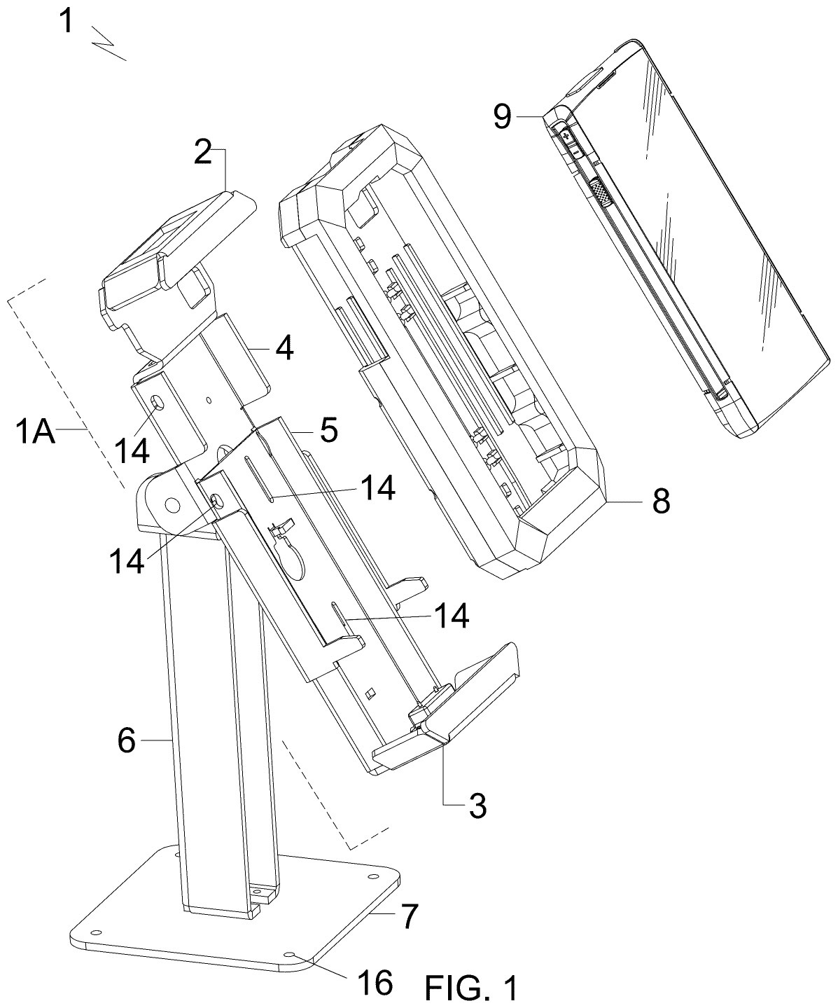

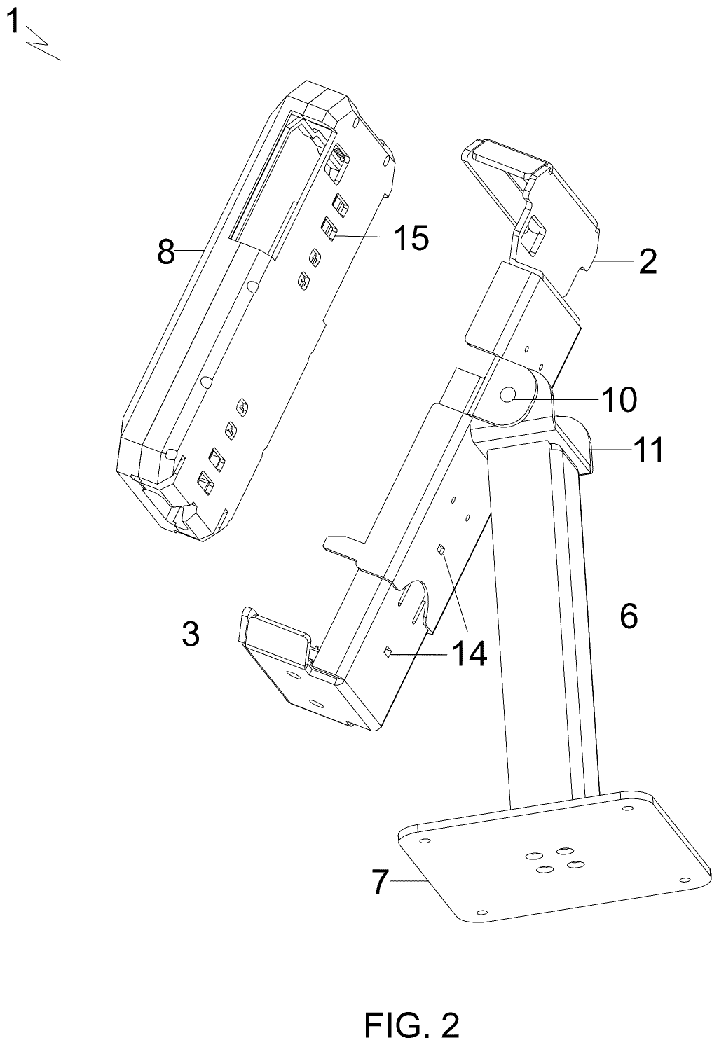

Referring now to any of the accompanying FIGS. 1-3, an AIDC device cradle 1 is illustrated. In one embodiment, the AIDC device cradle 1 comprises a tray 1A configured to receive an AIDC device 9. In one embodiment, the tray 1A is rectangular and sized and shaped to receive a rectangular AIDC device. In some embodiments, the tray 1A is configured to receive an AIDC case 8, wherein the AIDC case 8 is configured to receive the AIDC device 9. Likewise, the AIDC case 8 is rectangular and configured to receive a rectangular AIDC device 9 as illustrated in the accompanying FIGS. 1-3. Although, the popular AIDC devices and corresponding AIDC cases are rectangular, it should be understood that the shape may vary in alternative embodiments such that other shaped AIDC devices may be accommodated. Further, for the purposes of this disclosure, the AIDC device may be a PDA (personal digital assistant) device.

Advantageously, in one embodiment, the tray 1A is expandable such that multiple sized AIDC cases and AIDC devices may be received by the tray 1A. In one embodiment, the expandable tray 1A comprises an upper bracket 2 and a lower bracket 3 each configured to contract and expand towards and away from each other respectively. Both the upper bracket 2 and the lower bracket 3 have the freedom of motion to independently move in relation to each other such that one bracket may be fixed while the other is adjusted. In some embodiments, the upper bracket 2 and the lower bracket 3 includes side walls 4 and 5 respectively, wherein the side walls are perpendicular to the longitudinal axis of the tray 1A. The side walls 4 and 5 help secure the AIDC device and/or AIDC case from lateral movement within the tray 1A. In one embodiment, the side walls and/or brackets include openings/slots 14 configured to receive a plurality of fastener options or locks, wherein the fasteners enable the AIDC device cradle to lock in the AIDC device and/or AIDC case within the tray 1A. In one embodiment, the fasteners are screws, but other securement methods or elements may be used as well known in the art, including but not limited to cam levers or other quick locking devices. In some embodiments, slots 15 are also provided on the AIDC case such that the AIDC case and AIDC device is capable of being locked within the present invention.

In one embodiment, the AIDC device cradle 1 further comprises a stand comprised of post 6 attached to a base plate 7, wherein the stand includes an axle head 11 on the top portion of the post 6. In one embodiment, the tray 1A is rotatably connected to the axle head 11 via pivot pin 10, which enables the tray 1A and attached AIDC device to rotate about the axle head 11 to any desirable angle. In some embodiments, the base plate includes holes 16 enabling fasteners to secure the base plate to a surface.

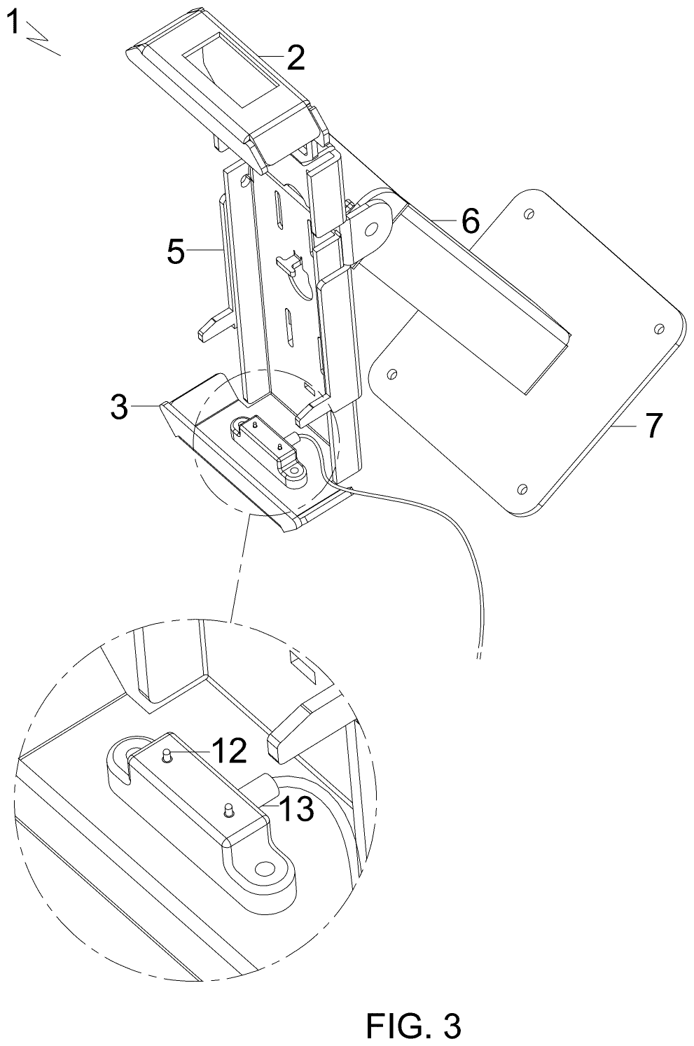

Best seen in FIG. 3, a charger connection 12 is integrated on the lower bracket 3 of the AIDC cradle device 1, wherein the charger connection 12 provides power to the AIDC device via power cord 13 when the AIDC device is situated in the tray 1A. In other embodiments, the AIDC device is configured to change wirelessly via an integrated wireless charging component on the AIDC cradle. In some embodiments, other ports or connections may be provided for charging, data transfer, etc. such as USB, serial, parallel ports, or similar.

It should be understood that the materials may vary, however, in one embodiment the AIDC cradle device 1 including the tray 1A, brackets, stand, and base are constructed from a rigid material, such as metal or plastic. In one embodiment, the AIDC case 8 is made from a rigid yet flexible material, including but not limited to rubber, silicone, PVC, ABS plastic, or similar.

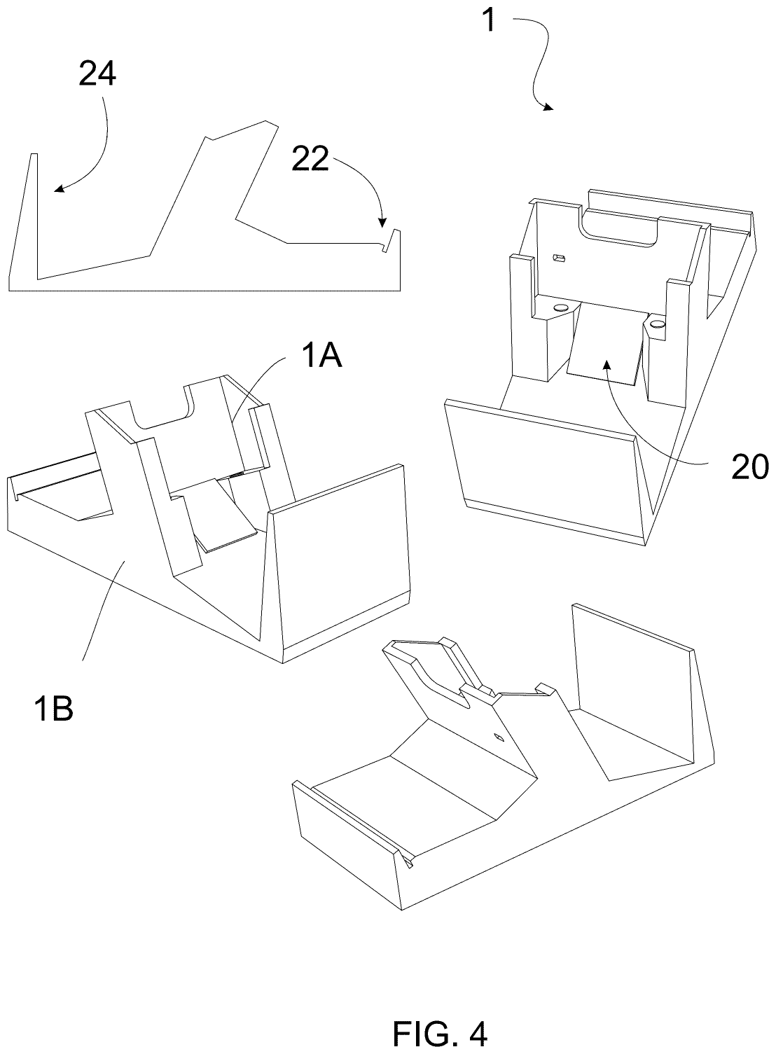

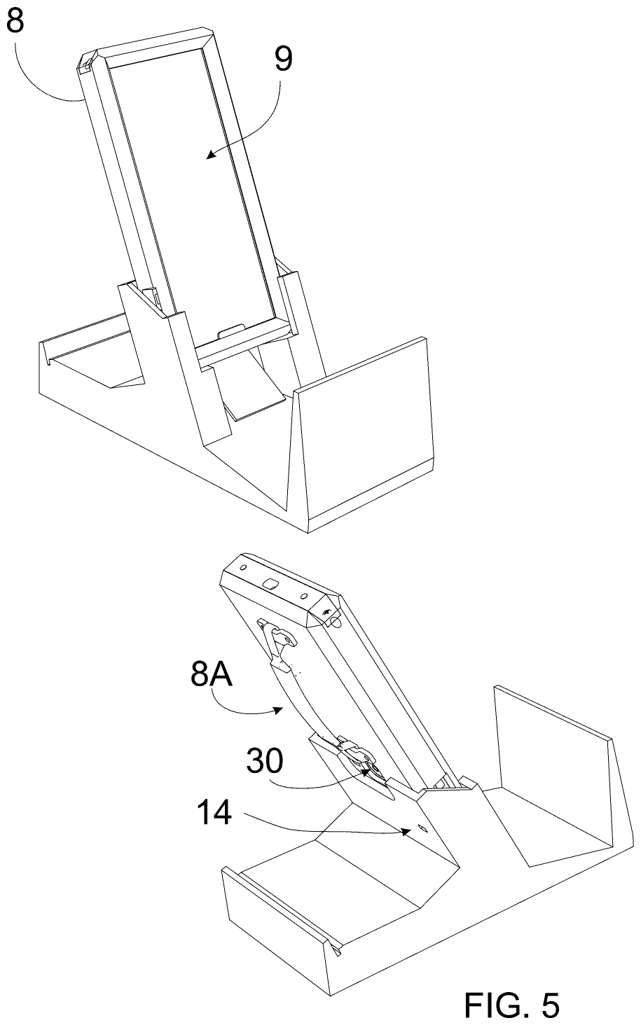

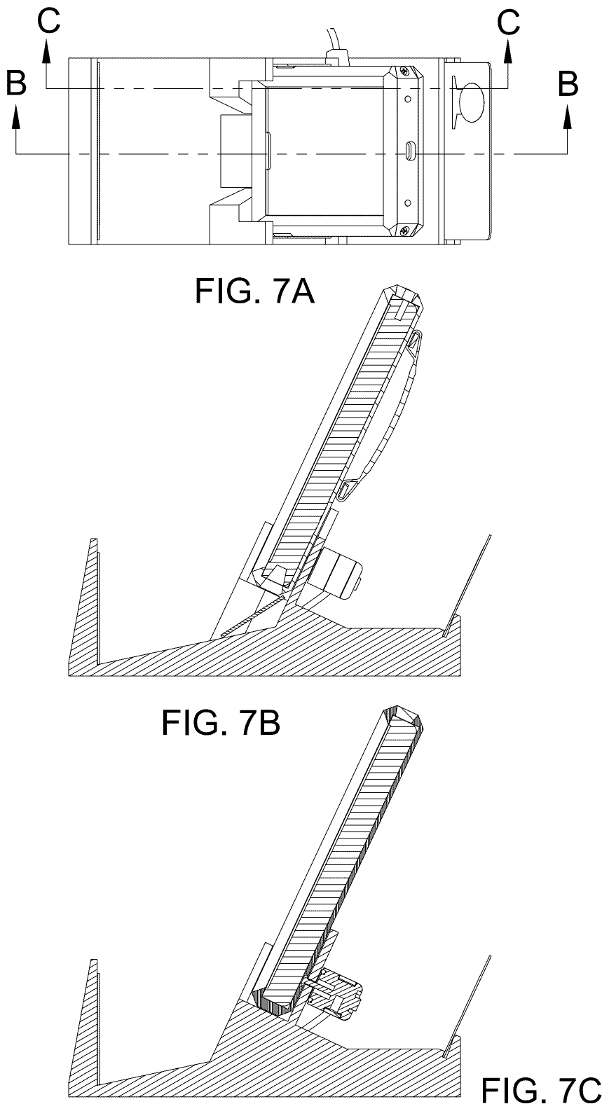

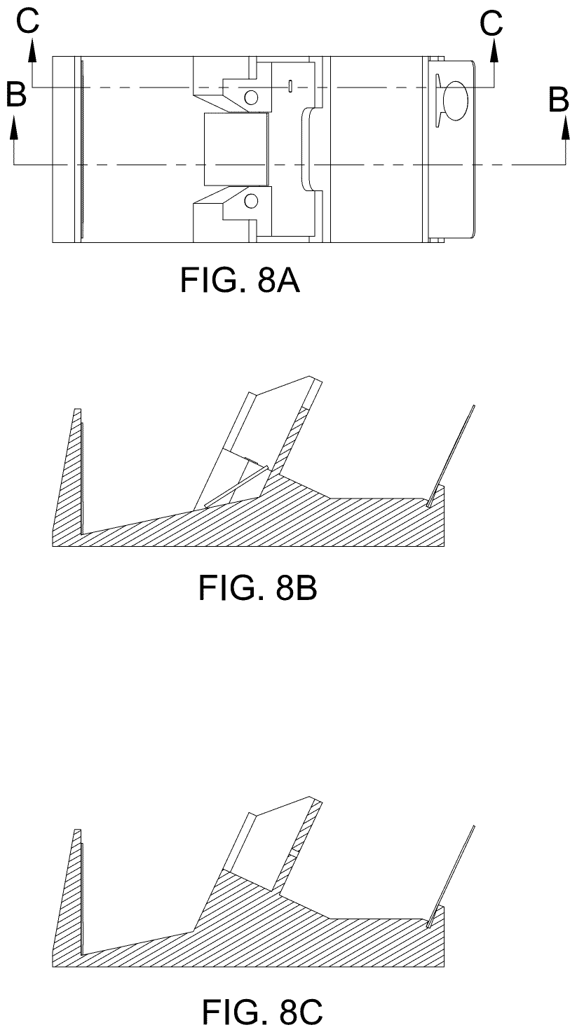

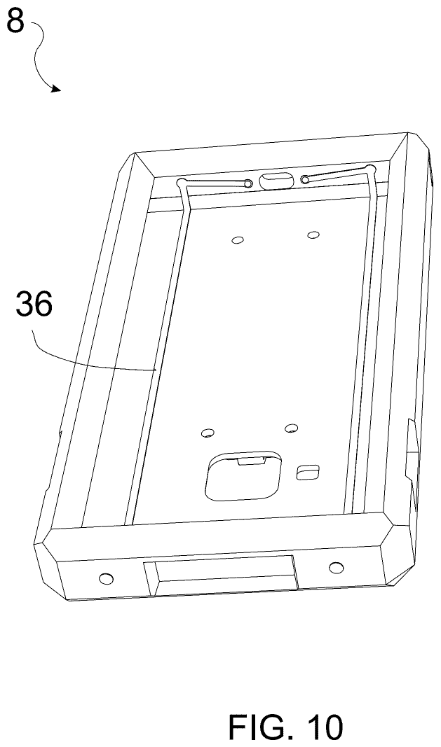

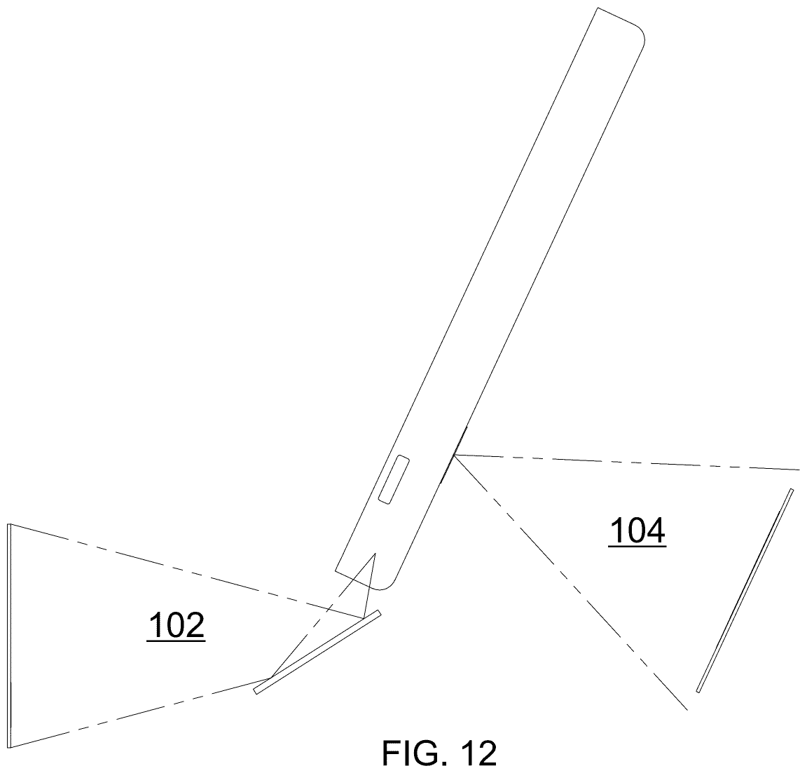

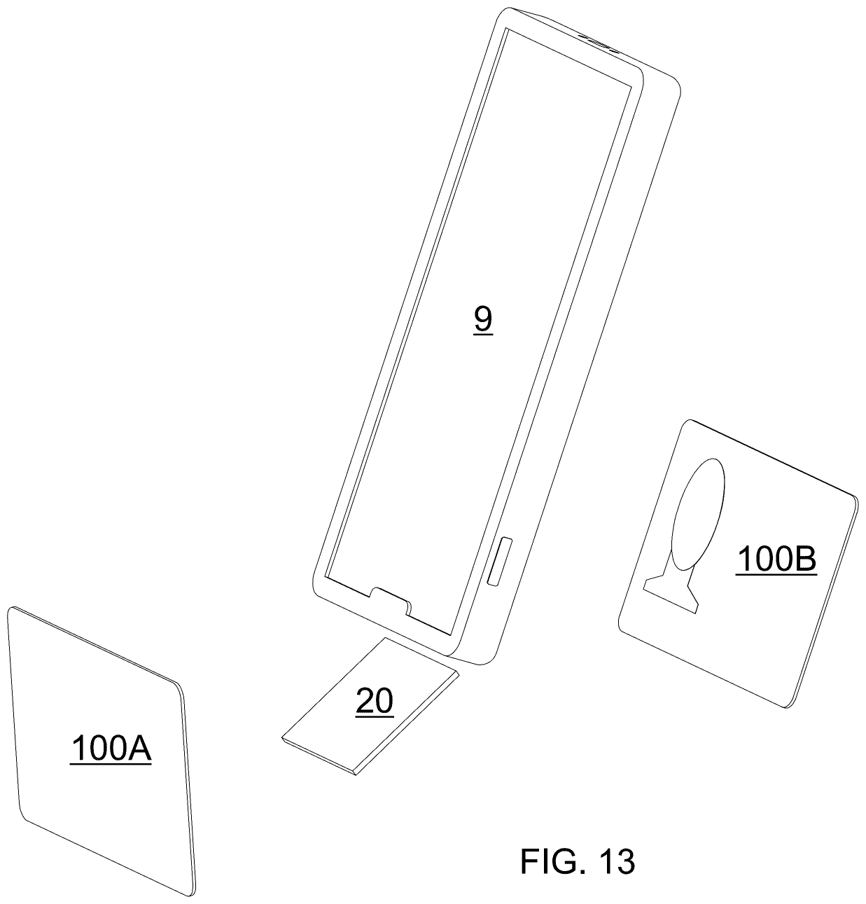

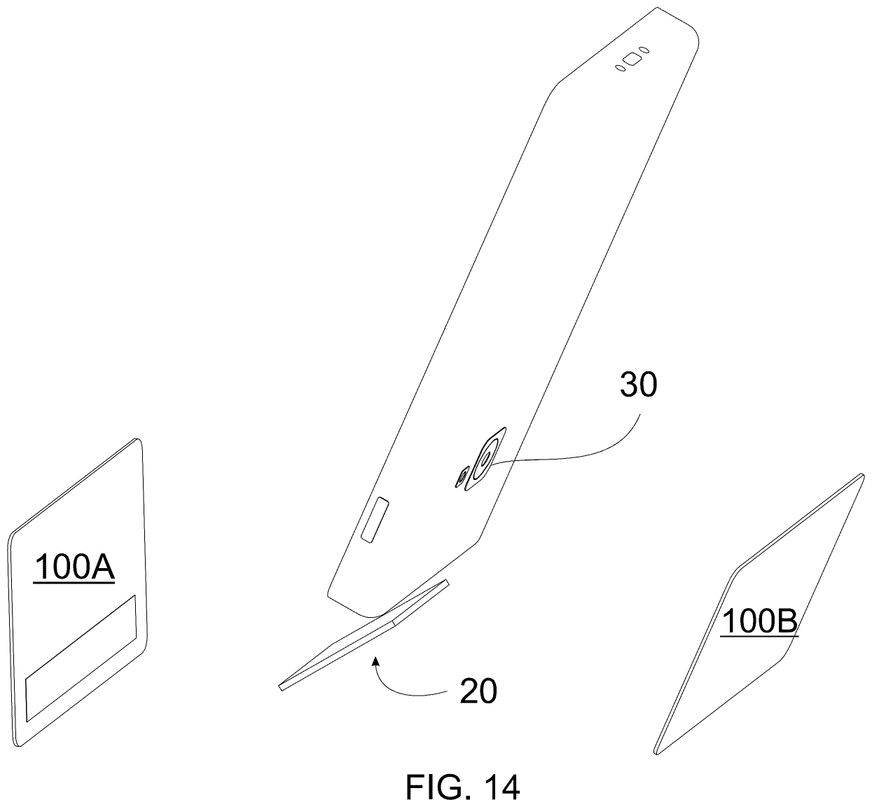

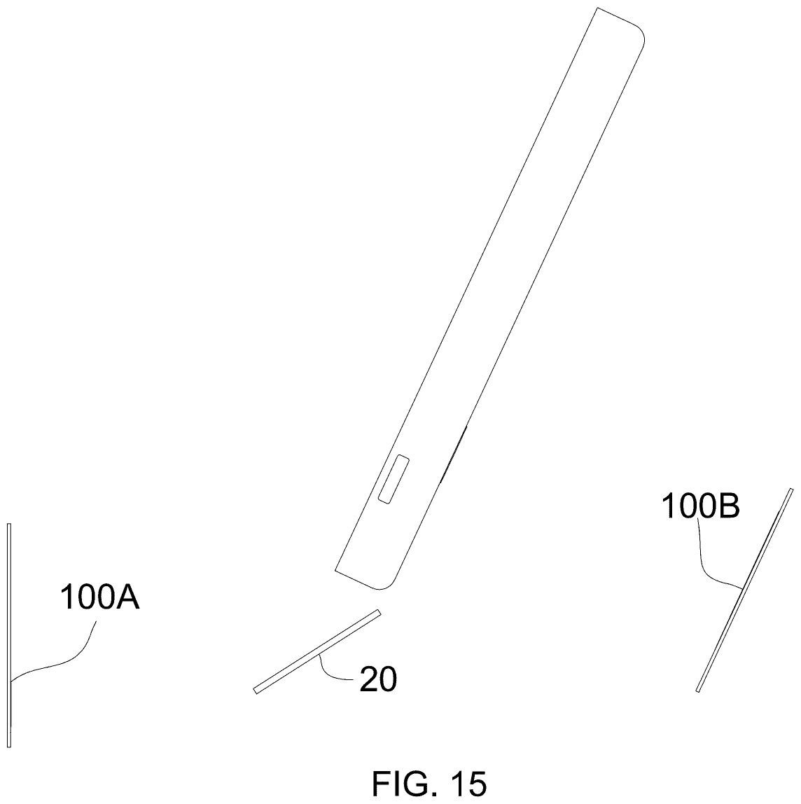

Referring now to FIGS. 4-15, in some embodiments, an AIDC device cradle is configured as a docking station 1B. The docking station 1B is configured to receive and secure an AIDC, PDA, or similar device 9. As shown in FIG. 4 and FIG. 5, the cradle includes a receiving area 1A that is sized and shaped to accommodate a case 8 enclosing the AIDC/PDA device. In some embodiments, the case 8 includes a handle 8A, as well as electrical contacts 36 (FIG. 10) aligned to mate with corresponding contacts in the docking station 1B for charging and/or data transfer.

In one embodiment, the receiving area for the AIDC/PDA is an upward facing rectangular pocket formed by front, back, left, and right walls, along with a bottom surface. Further, the docking station includes a front wall cut away to expose a screen of the AIDC/PDA device when the device is placed in the cradle and a back wall cut away to expose the camera of device when the AIDC/PDA is placed in the cradle. In some embodiments, the back wall is higher than the front wall when viewed from a position looking straight at the screen of the AIDC/PDA device which allows easier alignment of the AIDC/PDA when placing it into the docking station. In some embodiments, a tapered opening that is wider at the mouth can also be employed for this effect, and these principles can be applied to all four walls in any combination.

Advantageously, the docking station is configured to provide built-in structure to hold one or more licenses, such as a driver's license or ID. In some embodiments, the docking station 1B provides a stable housing with walls, slots, and grooves that guide both the AIDC/PDA device and driver's licenses into correct orientation for imaging and/or bar code scanning. In some embodiments, the docking station 1B may be manufactured from a rigid material such as ABS plastic, polycarbonate, or metal alloys.

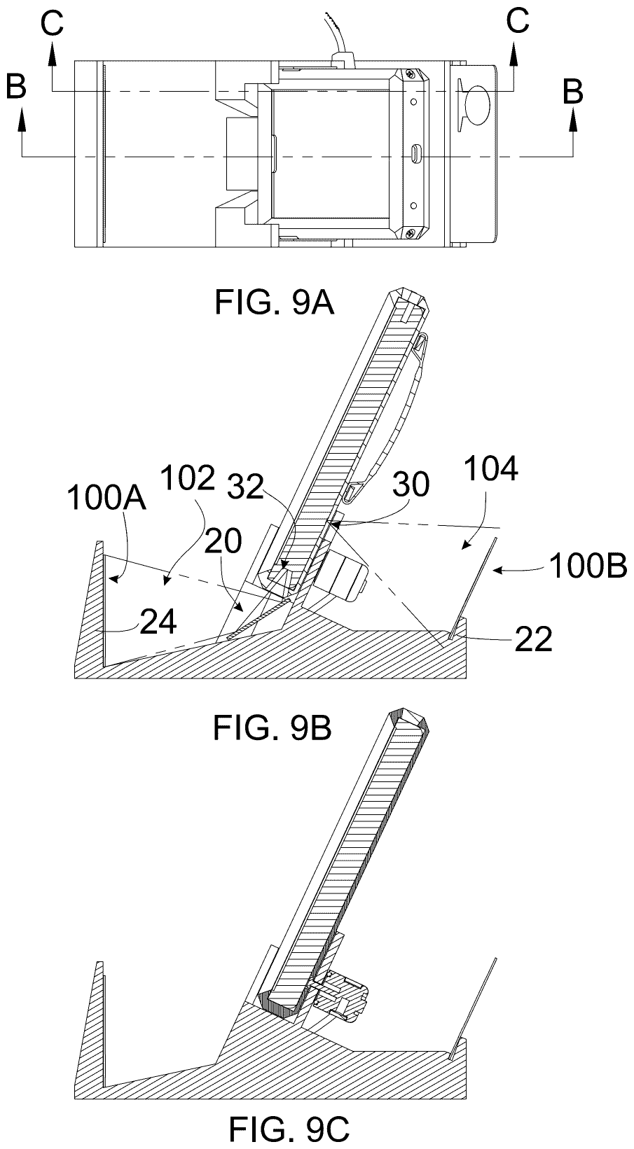

Best seen in FIGS. 4 and 9B, the docking station comprises a groove 22 on one end and a wall 24 on the opposite end which define two areas where driver's licenses may be inserted, herein license holders or license holder portions. In one embodiment, a first license (license 100B) is held in groove 22, and a second license (license 100A) is held via wall 24. Both license holder slots can optionally have bumps, walls, grooves or other geometric features positioned on one or both sides of either license which will help establish the proper lateral location of the license.

As previously mentioned, the AIDC/PDA device includes camera 30 and scanner 32. In some embodiments, the wall 24 also serves to block or contain the scanning beam from scanner 32 so that it does not project beyond the docking station's footprint, helping prevent accidental exposure of the beam outside the device.

In some embodiments, the docking station 1B includes a mirror 20 positioned to redirect a scanning beam (beam 102) from the scanner 32 toward the license 100A (see FIG. 9B for an exemplary beam path). Meanwhile, a separate beam 104 from the camera 30 (on the AIDC/PDA device) may be used to capture a full-face image of the license at the correct focal distance.

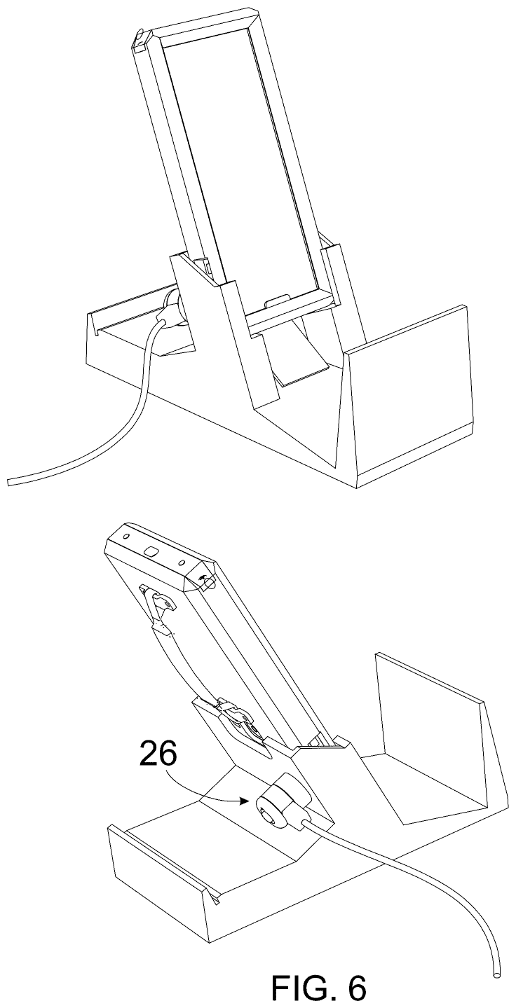

As illustrated in FIG. 6 and also depicted in cross-sectional views 7B, 7C, 8B, 8C, 9B, and 9C, the docking station 1B can incorporate a security lock 26. In one embodiment, security lock 26 extends through an aperture (14; FIG. 5) in the docking station 1B and engages a corresponding receptacle or locking feature on the Case 8. When engaged, the lock 26 prevents removal of the AIDC/PDA device from the docking station. It should be noted that in some embodiments, other methods to secure the AIDC/PDA device in the docking station may be employed, including but not limited to, springs, clips, magnets, or similar features. Likewise, in some embodiments, the AIDC/PDA device is held within the receiving tray and docking station via gravity alone.

Advantageously, there are multiple license potions the docking station may accommodate. In one embodiment, license 100A is placed against wall 24, such that the scanner beam 102 (reflected by mirror 20) reads a bar code on the license's back surface. In one embodiment, license 100B is positioned in groove 22 to be captured by camera 30. The illustrations also demonstrate how the docking station 1B accommodates an AIDC device in receiving area 1A while two licenses are placed in the designated slots.

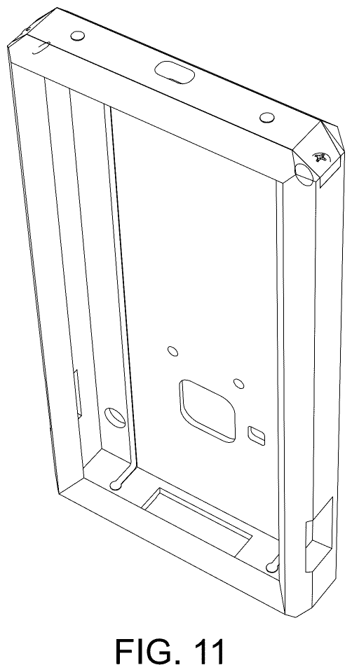

Best seen in FIGS. 10-11, details of the case 8 are illustrated. The Case 8 may be tailored to a particular brand or model of PDA but generally includes handle 8A, which may be a strap or handle portion enabling comfortable manual use and electrical contacts 36 to facilitate automatic charging and data transfer when the case 8 is seated in the docking station 1B. These contacts align with corresponding pins or connectors inside the station. Further, the case is provided with openings for the camera 30 and scanner 32, ensuring that these components are unobstructed and can project or receive beams (104 for the camera, 102 for the scanner) while docked.

In some embodiments, the AIDC device cradle further includes a wireless charging module integrated within the cradle. The wireless charging module may comprise a coil assembly, power circuitry, and any necessary shielding components, conforming to standard protocols such as Qi or other inductive coupling methods known in the art. When an AIDC/PDA or a protective case housing the AIDC/PDA includes a compatible receiver coil, placing the device in the receiver pocket of the cradle enables wireless transmission of power. This eliminates the need for direct cable connections or exposed electrical contacts. The cradle's wireless charging module can be embedded within the base, side, or rear portion of the receiver pocket, ensuring alignment between the transmitting coil on the cradle side and the receiving coil on the AIDC/PDA or case. In some variations, the cradle may include an indicator light or display to confirm active wireless power transfer.

It should be understood that the case material may vary, but the material selected should be strong, providing shock-absorbing features to protect the device from damage. Once placed inside the docking station 1B, the AIDC/PDA device remains securely in position, particularly if security lock 26 is engaged.

As previously discussed, camera 30 emits or detects a beam 104, while scanner 32 directs a beam 102 that can be reflected by mirror 20 to reach license 100A. It should be noted that the angle of the mirror may vary to direct the beam in a specific path. The mirror may be rotated, folded, removed, etc. to adjust the path of the scanner beam. The wall 24 acts as a shield, preventing the scanner beam 102 from traveling outward beyond the docking station footprint. By positioning the mirror 20 close to the scanner 32, the device can maintain compact dimensions while ensuring correct angles for scanning or imaging. Advantageously, the mirror allows scanning on the horizontal plan rather than directly below the scanner. More specifically, the mirror is positioned to create a lower-profile design by redirecting the scanner beam from a vertical orientation to a horizontal orientation relative to the countertop or surface the docking station sits, thereby allowing the AIDC device to be positioned closer to the base from traditional scanning docking stations. It should be noted that the size of the mirror is determined by how close and at what angle it is placed relative to the scanner. In the illustrated embodiment, the mirror size is minimized by placing it as close to the scanner as possible.

In some embodiments, the mirror is mounted at an angle between about 40° and 50° relative to the vertical path of the bar code reader's scanning beam. Experimental results suggest that positioning the mirror within this angular range provides an optimal balance between mirror size and horizontal redirection, enabling the scanning beam to strike a driver's license or bar code label at a substantially perpendicular orientation. Specifically, angles near 45° facilitate efficient beam reflection without requiring an excessively large mirror surface or causing undue distortion of the scanned image. However, minor variations within the 40°-50° range may be implemented depending on the specific dimensions of the cradle and the location of the scanner aperture.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

For example, in one embodiment, the mirror and a license holder portion are integrated into a detachable module that can be selectively coupled or decoupled from the main body of the cradle. This module may include the mirror, grooves, walls, or slots needed to position various identification cards or objects in the field of view of the scanner or camera. By removing or swapping the module, users can reconfigure the cradle for different scanning tasks, such as scanning objects of varying sizes, scanning larger documents, or simply removing the license holder if not needed. The detachable module may attach to the cradle via mechanical fasteners, latches, rails, magnets, or other securement means, permitting quick changes without altering the cradle's core functionality for holding and powering the AIDC/PDA.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and etc. members throughout the disclosure (and in particular, claims) are not used to show a serial or numerical limitation but instead are used to distinguish or identify the various members of the group.

What is claimed is:

1. An AIDC device cradle comprising:
a receiver formed by a plurality of walls, the receiver configured to hold a PDA or AIDC device having at least one camera and at least one bar code reader in a predefined orientation; and,
a mirror mounted in the cradle, the mirror being arranged to redirect a scanning beam from the at least one bar code reader from a vertical path to a horizontal path.

2. The AIDC device cradle of claim 1, further comprising a license holder portion disposed on or within the cradle, the license holder portion adapted to support a driver's license in a field of view of the at least one camera or the at least one bar code reader.

3. The AIDC device cradle of claim 1, wherein the receiver comprises a front wall cut away to expose a screen of the AIDC/PDA when the AIDC/PDA is placed in the cradle; and a back wall cut away to expose the camera of the AIDC/PDA when the AIDC/PDA is placed in the cradle.

4. The AIDC device cradle of claim 1, wherein the mirror is mounted at an angle between 40° and 50° relative to the vertical path of the scanning beam to optimize horizontal redirection.

5. The AIDC device cradle of claim 1, further comprising a detachable module including the mirror and license holder portion, configurable for scanning objects of varying sizes.

6. The AIDC device cradle of claim 2, wherein the license holder portion includes at least one wall configured to block a direct path of the scanning beam beyond an outer footprint of the cradle, thereby preventing stray laser light from extending outward.

7. The AIDC device cradle of claim 2, further comprising at least one groove or slot, the groove or slot being dimensioned to hold a second license or identification card in a position suitable for the at least one camera.

8. The AIDC device cradle of claim 1, further comprising a lock aperture aligned so that, when the AIDC/PDA is placed in the receiver, a security lock can be inserted through the lock aperture and into a corresponding recess of a protective case surrounding the PDA, thereby preventing removal of the AIDC/PDA from the cradle.

9. The AIDC device cradle of claim 1, wherein the mirror is positioned in close proximity to an emission point of the at least one bar code reader so as to minimize the required size of the mirror while maintaining an effective scanning angle.

10. The AIDC device cradle of claim 1, further comprising electrical contacts arranged to connect with corresponding contacts on the AIDC/PDA or on a case in which the AIDC/PDA is housed, thereby enabling data or power transmission when the AIDC/PDA is positioned in the receiver.

11. The AIDC device cradle of claim 1, further comprising a wireless charging module integrated within the cradle, configured to wirelessly transmit power to a corresponding receiver on the AIDC/PDA or on a case in which the AIDC/PDA is housed, thereby enabling power transmission when the AIDC/PDA is positioned in the receiver.

12. The AIDC device cradle of claim 2, wherein the license holder portion includes opposing lateral features selected from the group consisting of bumps, ribs, and grooves, which establish lateral positioning of the license relative to the bar code reader's optical axis.

13. The AIDC device cradle of claim 1, wherein walls of the receiver form a tapered 13. opening at an upper portion to guide insertion of the AIDC/PDA into the cradle and help align the PDA with the mirror.
